(19) United States
(12) Patent Application Publication
(10) Pub. No.: US 2009/0143096 A1
(43) Pub. Date: Jun. 4, 2009

(54) Wireless earphone structure

(75) Inventor: Su-Yi Chang, Taipei (TW)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 11/987,305

(22) Filed: Nov. 29, 2007

(51) Int. Cl. H04M 1/00

(52) U.S. Cl. 455/556.1

(57) ABSTRACT

A wireless earphone structure includes a housing, a wireless transceiver module mounted in the housing for receiving music or a phone call generated by a mobile communication device, a fixed earphone mounted on a surface of the housing for playing the music or the phone call, and a phone call switch slidably disposed on the surface of the housing. When the phone call switch is not pushed, the wireless transceiver module will receive the music and transmit it to the fixed earphone. When the phone call switch is pushed, the wireless transceiver module will receive the phone call and transmit it to the fixed earphone. Therefore, a user can use the phone call switch to select and listen to the music or the phone call.

### FIELD OF THE INVENTION

The present invention relates to an earphone structure, and more particularly to a wireless earphone structure having a phone call switch for being switched to broadcast music or phone call generated by the mobile communication device.

### BACKGROUND OF THE INVENTION

By a mobile phone, if the mobile phone is ringing when a user is driving or riding, the user generally has no choice but to hold the mobile phone to answer a phone call by one of his or her hands and keep driving or riding by the other hand regardless of inevitably increasing the danger of driving or riding. To solve the foregoing problems, related manufacturers further developed a hands-free earphone applied to a mobile phone. When the mobile phone is ringing, the user can conveniently answer the phone call via the hands-free earphone without manually operating the mobile phone. However, one of the shortcomings of the hands-free earphone is that a signal cable thereof cannot be kept and accommodated properly, while the signal cable may be disorderly intertwisted. As a result, before/after the user uses the hands-free earphone, the user must unwind the intertwisted signal cable resulting in wasting a lot of time and lowering the operation convenience thereof.

Therefore, referring now to FIG. 1, related manufacturers further develop a wireless Bluetooth earphone comprising a main body 1 which is provided with a hanger 11, an earphone 13, a microphone 15, and a switch 17. The hanger 11 has one end connected to one end of the main body 1, and the hanger 11 is shaped in a curved configuration. The earphone 13 is provided on the other end of the hanger 11. When a user uses the wireless Bluetooth earphone, the hanger 11 is hanged on a user's ear along an outer profile of the ear, so as to plug the earphone 13 into the ear. The microphone 15 is also provided on the other end of the main body 1. The switch 17 is provided on a surface of the main body 1. Furthermore, the main body 1 is provided with a Bluetooth module (not shown) therein, wherein the Bluetooth module is used to wirelessly connect to a mobile phone (not shown) for receiving music, so that the user can listen to the music. When the mobile phone is ringing, the user can press the switch 17 to pause the music and receive a call followed by answering the call via the microphone 15.

However, there are still several shortcomings when the user/consumer uses the traditional wireless Bluetooth earphone, resulting in lowering the operation convenience thereof. Firstly, if the mobile phone is ringing when the user is listening to music, the user can press the switch 17 to pause the music and receive a phone call. If the user wants to continue listening to the music after answering the phone call, the user must manually operate the mobile phone to play the music again. Thereby, if the mobile phone is frequently ringing, the user generally has no choice but to repeatedly operate the mobile phone to play the music again, resulting in inconvenience to the user. Secondly, when the user uses the wireless Bluetooth earphone, the hanger 11 is hanged on the user's ear along an outer profile of the ear. Because everybody has a pair of ears with individual outer profile and size different from that of others, the same earphone 13 may not fit precisely into the ear of some users when the same hanger 11 is hanged on the ear, resulting in the possible discomfort of the ear. Thus, it is an important issue for related manufacturers to solve the inconvenience derived from the foregoing problems.

### SUMMARY OF THE INVENTION

A primary object of the present invention is to provide a wireless earphone structure, which is provided with a housing, a wireless transceiver module, a fixed earphone, and a phone call switch, the wireless transceiver module is mounted in the housing for receiving music or phone calls generated by a mobile communication device, the fixed earphone is mounted on a surface of the housing and adjacent to an end thereof for playing the music or the phone call, the phone call switch is slidably disposed on the surface of the housing and adjacent to the other end thereof, if the phone call switch is pushed outward in relation to the other end of the housing, the wireless transceiver module will receive the phone call of the mobile communication device and transmit it to the fixed earphone, so that a user can listen to the phone call; and if the phone call switch is pushed inward in relation to the other end of the housing, the wireless transceiver module will receive the music and transmit it to the fixed earphone, so that the user can listen to the music. Thus, the user can select to listen to the music or the phone call via the phone call switch, so as to solve the problems existing in the traditional wireless Bluetooth earphone.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic view of a traditional wireless Bluetooth earphone;

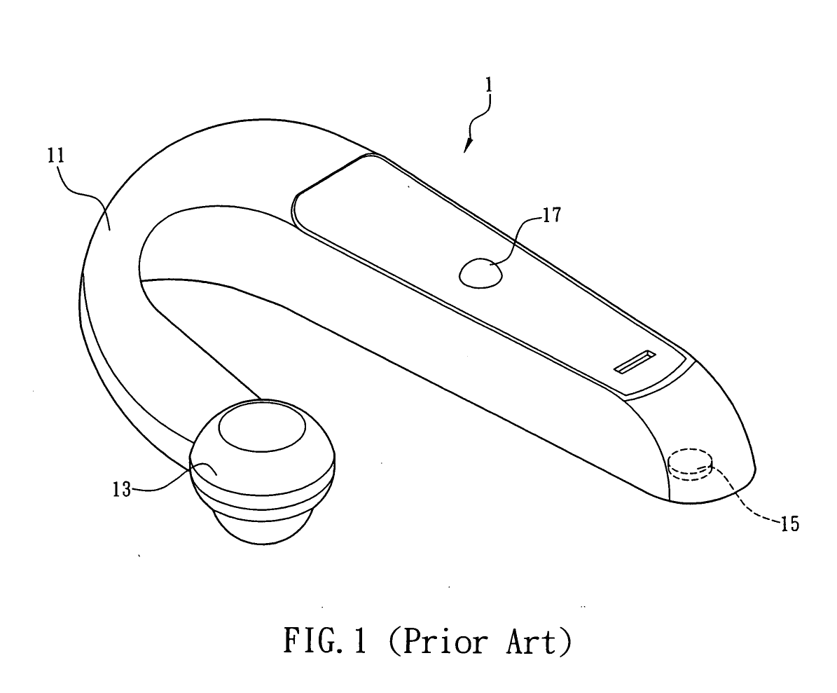

FIG. 2 is a schematic view of a wireless earphone structure according to a preferred embodiment of the present invention;

FIG. 3 is a left side view of the wireless earphone structure according to the preferred embodiment of the present invention; and

FIG. 4 is a block diagram of the wireless earphone structure according to the preferred embodiment of the present invention.

### DETAILED DESCRIPTION OF THE PREFERRED EMBODIMENTS

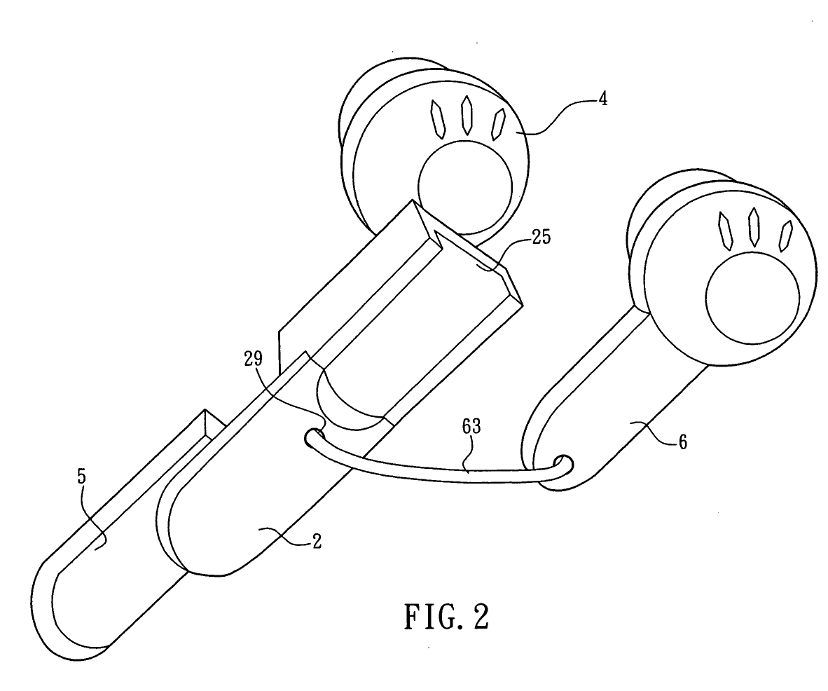

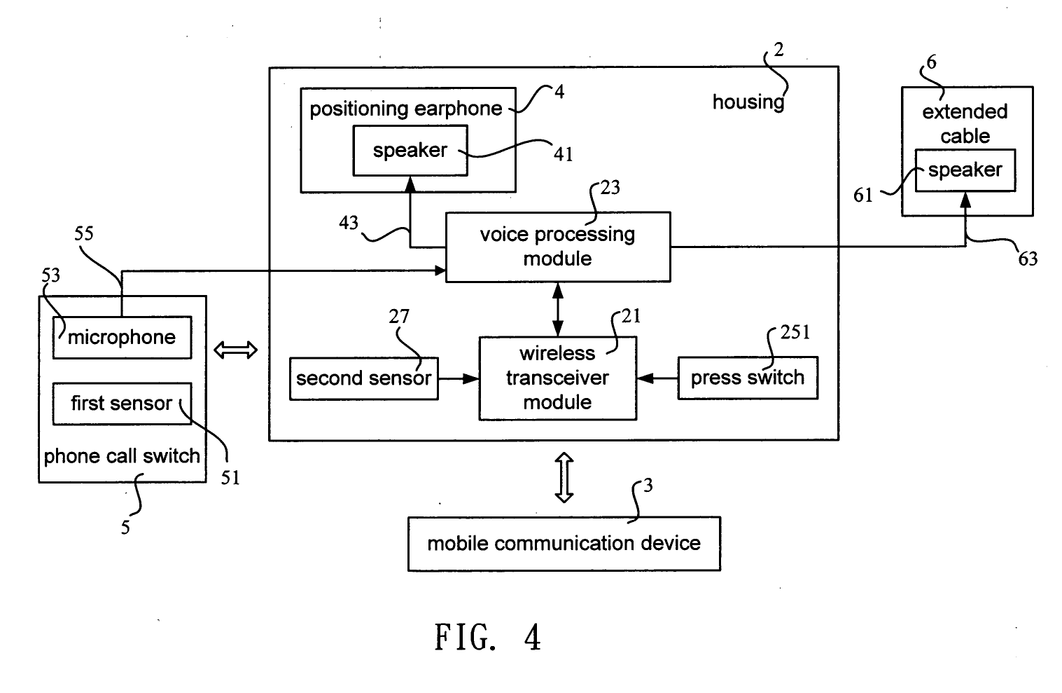

Referring now to FIGS. 2 and 4, a wireless earphone structure according to a preferred embodiment of the present invention is illustrated. As shown, the wireless earphone structure comprises a housing 2, a wireless transceiver module 21, a fixed earphone 4, and a phone call switch 5. The wireless transceiver module 21 (such as a Bluetooth module) is mounted in the housing 2, and used to be wirelessly connected to a mobile communication device 3 (such as a mobile phone) for receiving music (such as music) or a phone call transmitted from the mobile communication device 3. The fixed earphone 4 is mounted on a surface of the housing 2 adjacent to an end thereof. The phone call switch 5 is slidably disposed on the surface of the housing 2 adjacent to the other end thereof. If the phone call switch 5 is not switched, the wireless transceiver module 21 will receive the music and transmit it to the fixed earphone 4, so that the user can listen to the music. If the phone call switch 5 is switched outward in relation to the other end of the housing 2, the wireless transceiver module 21 will receive the phone call and transmit it to the fixed earphone 4. Therefore, a user can select to listen to the music or the phone call via the phone call switch 5 without manually operating the mobile communication device 3.

In the preferred embodiment of the present invention, the wireless earphone structure further comprises a voice processing module 23 in the housing 2, wherein the voice processing module 23 is electrically connected to the wireless transceiver module 21. Thereby, when the wireless transceiver module 21 receives the music of the mobile communication device 3, the voice processing module 23 is used to execute an analog conversion process to process the music. When the wireless transceiver module 21 receives the phone call of the mobile communication device 3, the voice processing module 23 is used to execute an analog conversion process to process the phone call.

In the preferred embodiment of the present invention, the wireless earphone structure further comprises an extended earphone 6 inserted in a recess 25 on a backside of the housing 2 and adjacent to an end thereof. The extended earphone 6 is provided with a speaker 61 and an extended cable 63. The speaker 61 is mounted in an end of the extended earphone 6 opposite to the recess 25, and used to play the music processed by the analog conversion process. The extended cable 63 has a first end electrically connected to the speaker 61 and a second end extended out of the other end of the extended earphone 6 and penetrated into the housing 2 through an opening 29 formed on the backside of the housing 2 for being electrically connected to the voice processing module 23.

In the preferred embodiment of the present invention, the recess 25 is provided with a press switch 251. When the extended earphone 6 is drawn out of the recess 25, the press switch 251 is released from a biased state biased by the extended earphone 6, and then outputs a first control signal to the wireless transceiver module 21. In other words, when the extended earphone 6 is drawn out of the recess 25, the wireless transceiver module 21 receives the first control signal followed by receiving the music and transmitting it to the extended earphone 6 for playing. Therefore, once the user plugs the extended earphone 6 into the other ear of the user, the user can listen to the music from both of the fixed earphone 4 and the extended earphone 6.

In the preferred embodiment of the present invention, the wireless earphone structure further comprises a first sensor 51 and a second sensor 27 formed between the phone call switch 5 and the housing 2, wherein the first sensor 51 is provided on a surface of the phone call switch 5 facing the housing 2, while the second sensor 27 is provided on a corresponding surface of the housing 2 and adjacent to the other end thereof. When the phone call switch 5 slides toward the other end of the housing 2, the first sensor 51 will be aligned with the second sensor 27, so that the second sensor 27 can output a second control signal to the wireless transceiver module 21 for allowing the wireless transceiver module 21 to receive the phone call. In other words, when the user pushes the phone call switch 5 to slide out of the other end of the housing 2, the wireless transceiver module 21 will receive the phone call, and then the voice processing module 23 will execute the analog conversion process to process the phone call, so that the phone call is transmitted to the fixed earphone 4 for playing.

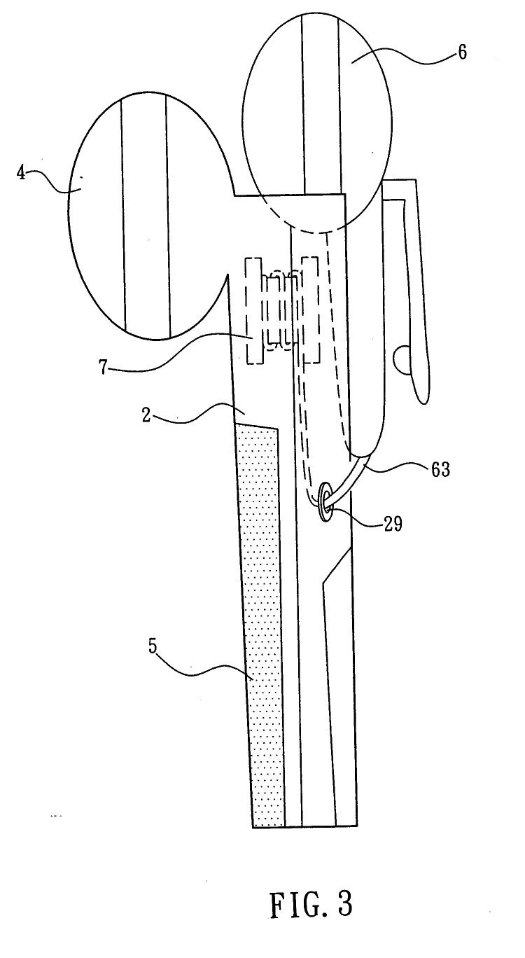

Referring to FIGS. 2 and 3, in the preferred embodiment of the present invention, the wireless earphone structure further comprises a winding module 7 in the housing 2, wherein a remaining portion between the two ends of the extended cable 63 is wound on the winding module 7 in the housing 2. Furthermore, when the extended cable 63 is drawn out of the winding module 7 about a predetermined length, the winding module 7 can be used to engage the extended cable 63, and prevent the extended cable 63 from retracting back to the winding module 7. When the user slightly draws the extended cable 63 again, the winding module 7 will continuously rotate in a reverse direction opposite to the drawing direction, so that the drawn portion of the extended cable 63 can retract back to the winding module 7. After this, the winding module 7 stops rotating.

Referring back to FIGS. 2 and 4, in the preferred embodiment of the present invention, the fixed earphone 4 of the wireless earphone structure further comprises a speaker 41 and a voice cable 43. The speaker 41 is mounted in an end of the fixed earphone 4 opposite to the housing 2, and used to play the music processed by the analog conversion process. The voice cable 43 has a first end electrically connected to the speaker 41, and a second end electrically connected to the voice processing module 23. Thus, the speaker 41 can receive the music processed by the analog conversion process of the voice processing module 23 for playing via the connection between the voice cable 43 and the voice processing module 23.

Referring still to FIGS. 2 and 4, in the preferred embodiment of the present invention, the phone call switch 5 of the wireless earphone structure further comprises a microphone 53 and a transmission cable 55. The microphone 53 is mounted on a side edge of the phone call switch 5, and used to receive an exterior voice generated by the user. The transmission cable 55 has a first end electrically connected to the microphone 53, and a second end electrically connected to the voice processing module 23. The exterior voice generated by the user is transmitted to the voice processing module 23 for being processed and converted into a voice signal via the microphone 53 and the transmission cable 55. Then, the voice signal is transmitted to the mobile communication device 3 via the wireless transceiver module 21. Therefore, the user can wirelessly answer a phone call from the mobile communication device 3 via the wireless earphone structure.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A wireless earphone structure, comprising:
a housing;
a wireless transceiver module mounted in the housing for receiving music or a phone call transmitted by a mobile communication device;
a fixed earphone mounted on a surface of the housing adjacent to an end thereof for playing the music or the phone call; and
a phone call switch slidably disposed on the surface of the housing adjacent to the other end thereof, wherein when the phone call switch is pushed outward in relation to the other end of the housing, the wireless transceiver module receives the phone call.

2. The wireless earphone structure of claim 1, further comprising a voice processing module, wherein the voice processing module is electrically connected to the wireless transceiver module for executing an analog conversion process to process the music or the phone call.

3. The wireless earphone structure of claim 2, further comprising an extended earphone inserted in a recess on a backside of the housing and adjacent to the end, wherein the extended earphone comprises:
a speaker mounted in an end of the extended earphone opposite to the recess for playing the music processed by the analog conversion process; and
an extended cable having a first end electrically connected to the speaker and a second end extended out of the other end of the extended earphone and penetrated into the housing through an opening formed on the backside of the housing for being electrically connected to the voice processing module.

4. The wireless earphone structure of claim 3, wherein the recess is provided with a press switch, when the extended earphone is drawn out of the recess, the press switch is released from a biased state biased by the extended earphone, and then outputs a first control signal to the wireless transceiver module, so that the wireless transceiver module receives the music.

5. The wireless earphone structure of claim 4, further comprising a first sensor and a second sensor respectively formed between the phone call switch and the housing, wherein the first sensor is provided on a surface of the phone call switch facing the housing, and the second sensor is provided on a corresponding surface of the housing and adjacent to the other end thereof, when the phone call switch slides toward the other end of the housing, the first sensor is aligned with the second sensor, so that the second sensor outputs a second control signal to the wireless transceiver module for allowing the wireless transceiver module to receive the phone call.

6. The wireless earphone structure of claim 5, further comprising a winding module in the housing, wherein a portion between two ends of the extended cable is wound on the winding module in the housing.

7. The wireless earphone structure of claim 5, wherein the fixed earphone further comprises:
a speaker mounted in an end of the fixed earphone opposite to the housing for playing the music processed by the analog conversion process; and
a voice cable having a first end electrically connected to the speaker and a second end electrically connected to the voice processing module.

8. The wireless earphone structure of claim 5, wherein the phone call switch further comprises:
a microphone mounted on a side edge of the phone call switch for receiving an exterior voice which is transmitted to the voice processing module for being processed and converted into a voice signal; and
a transmission cable having a first end electrically connected to the microphone and a second end electrically connected to the voice processing module.
